(19) United States
(12) Patent Application Publication
(10) Pub. No.: US 2016/0239869 A1
(43) Pub. Date: Aug. 18, 2016

(54) VARIOUS METHODS AND APPARATUSES FOR REAL TIME BIDDING AND OPTIMIZATION OF VIDEO ADS FOR ORGANIC AND PAID MEDIA

(71) Applicant: Buzztala, LLC, New York, NY (US)

(72) Inventors: Henry Wong, Sausalito, CA (US); Jay DeDapper, New York, NY (US); Kelly Dyer, New York, NY (US)

(73) Assignee: Buzztala, LLC a New York Corporation

(21) Appl. No.: 15/043,093

(22) Filed: Feb. 12, 2016

Related U.S. Application Data
(60) Provisional application No. 62/117,357, filed on Feb. 17, 2015.

(51) Int. Cl. G06Q 30/02

(52) U.S. Cl. CPC G06Q 30/0256; G06Q 30/0277

(57) ABSTRACT

Apparatuses, systems, and processes are discussed for an advertisement network including an analytics engine, an Ad server, and a database. The analytics engine can be configured to collect and analyze signal data about tracked statistics and data on advertising effectiveness and search information. The analytics engine can also be configured to work with the Ad server. The database can be configured to store multiple instances of one or more product video advertisements, each of the multiple instances varying in content and containing an embedded link. The database can have an index of the multiple instances of the one or more product video advertisements. The analytics engine can be configured to work with the Ad server to select and deliver a first instance of a product video advertisement optimized for a search engine-results page based on the signal data.

### CROSS-REFERENCE

This Non-Provisional application claims the benefit of U.S. Provisional Patent Application No. 62/117,357, filed Feb. 17, 2015, which application is incorporated herein by reference in its entirety.

### FIELD

The design generally relates to Advertising Networks and in an embodiment real time bidding and optimization of video ads for organic and paid media.

### BACKGROUND

Typically, an online advertising network or Ad network connects advertisers to web sites that want to host advertisements. A function of an Ad network is aggregation of ad space supply from publishers and matching it with advertiser demand.

### SUMMARY

Apparatuses, systems, and processes are discussed for an advertisement network.

In some embodiments, an apparatus for an advertisement network can include an analytics engine, an Ad server, and a database. The analytics engine can be configured to collect and analyze signal data about tracked statistics and data on advertising effectiveness and search information. The analytics engine can also be configured to work with the Ad server. The database can be configured to store multiple instances of one or more product video advertisements, each of the multiple instances varying in content and containing an embedded link. The database can have an index of the multiple instances of the one or more product video advertisements. The analytics engine can be configured to work with the Ad server to select and deliver a first instance of a product video advertisement optimized for a search engine-results page based on the signal data.

In some embodiments, a system has the foregoing apparatus and one or more servers of at least one advertisement host or publisher.

In some embodiments, a method for an advertisement network can include receiving into an ingest engine database of an advertisement network a product data feed from an advertiser via one or more RSS feeds and/or user interfaces. The method can include parsing the product data feed by the ingest engine to identify and index key points about one or more products in the product data feed. The method can include scanning available content found online regarding the one or more products by an analytics engine. The method can include creating with a video processor one or more instances of one or more product video advertisements from the product data feed and the content found online. The method can include publishing the one or more product video advertisements online with a video publisher.

In an embodiment, the Ad network is able to allow multiple advertisers to bid in real time for the clicks associated with each product video advertisement. The Ad network is built and configured to use a combination of both free organic traffic (vis a vis top listings on a search page) as well as paid traffic in any Ad network. The Ad network is built and configured to provide numerous other advantages as well.

### BRIEF DESCRIPTION OF THE DRAWINGS

The multiple drawings refer to the example embodiments of the design.

FIG. 1 illustrates a block diagram of an example computing system that may be used in one or more of the servers and client devices discussed herein, in accordance with some embodiments.

FIG. 2 illustrates a block diagram of the real time bidding and optimization of video ads for organic and paid media hosted on an on-line provider site, in accordance with some embodiments.

FIG. 3 illustrates an example of a sequence of steps that occurs in the Ad network, in accordance with some embodiments.

FIG. 4 illustrates the Ad network from a perspective of a consumer on a client device, in accordance with some embodiments.

FIG. 5A illustrates search results in a search engine-results page, in accordance with some embodiments.

FIG. 5B illustrates search results in a search engine-results page, in accordance with some embodiments.

FIG. 6 illustrates an automated product video advertisement platform cooperating with the Ad network, in accordance with some embodiments.

FIG. 7A illustrates a video processor timeline for a product video advertisement, in accordance with some embodiments.

FIG. 7B illustrates elements for the video processor timeline of FIG. 7A, in accordance with some embodiments.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific Ad delivery services, named components, connections, number of databases, etc., in order to provide a thorough understanding of the present design. It will be apparent; however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details discussed in one embodiment may be reasonably implemented in another embodiment. The specific details may be varied from and still be contemplated to be within the spirit and scope of the present design.

### Abbreviations

Ad network: Advertisement network

### Product Listing Ad: PLA

### Product Video Ad: PVA

### Cost per Action/Acquisition: CPA

### Cost per Click: CPC

### Click Through Rate: CTR

### Pay per Click: PPC

### Search Engine Optimization: SEO

### Search Engine-Result Page: SERP

In general, the Ad network is configured to allow multiple advertisers to bid in real time for the clicks associated with each PVA. The Ad network is also built and configured to use a combination of both free organic traffic as well as paid traffic.

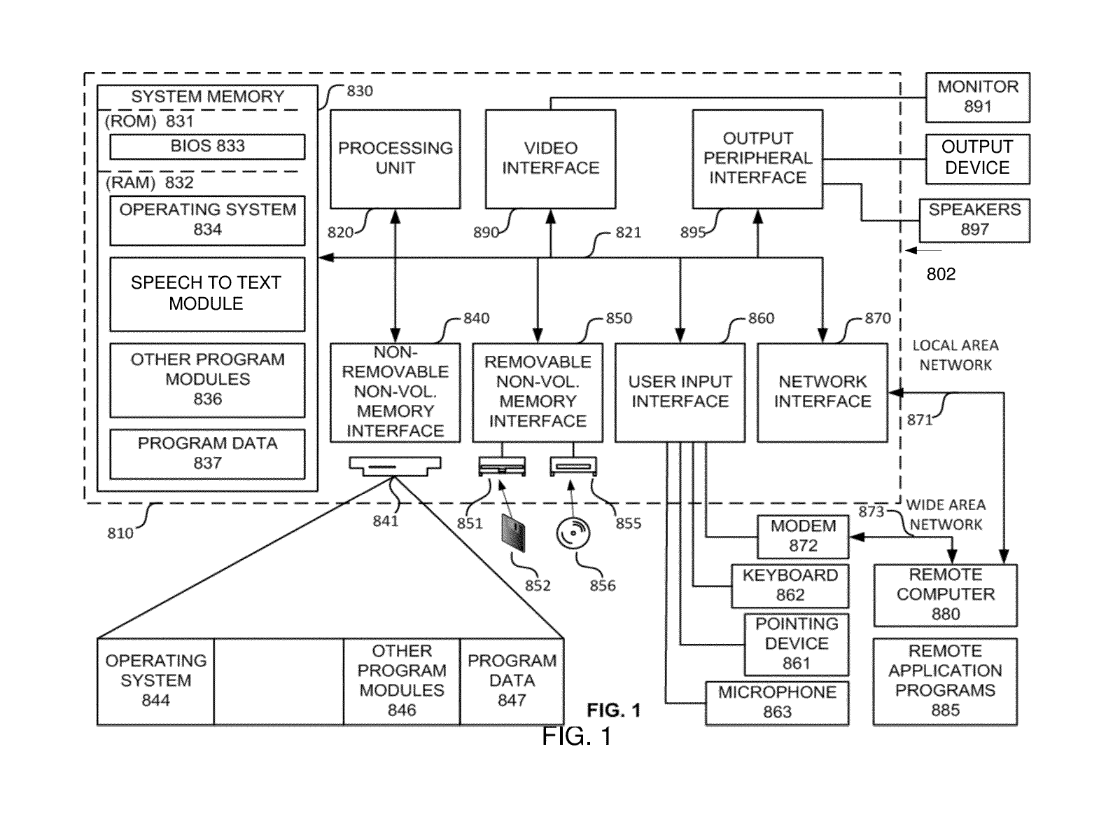

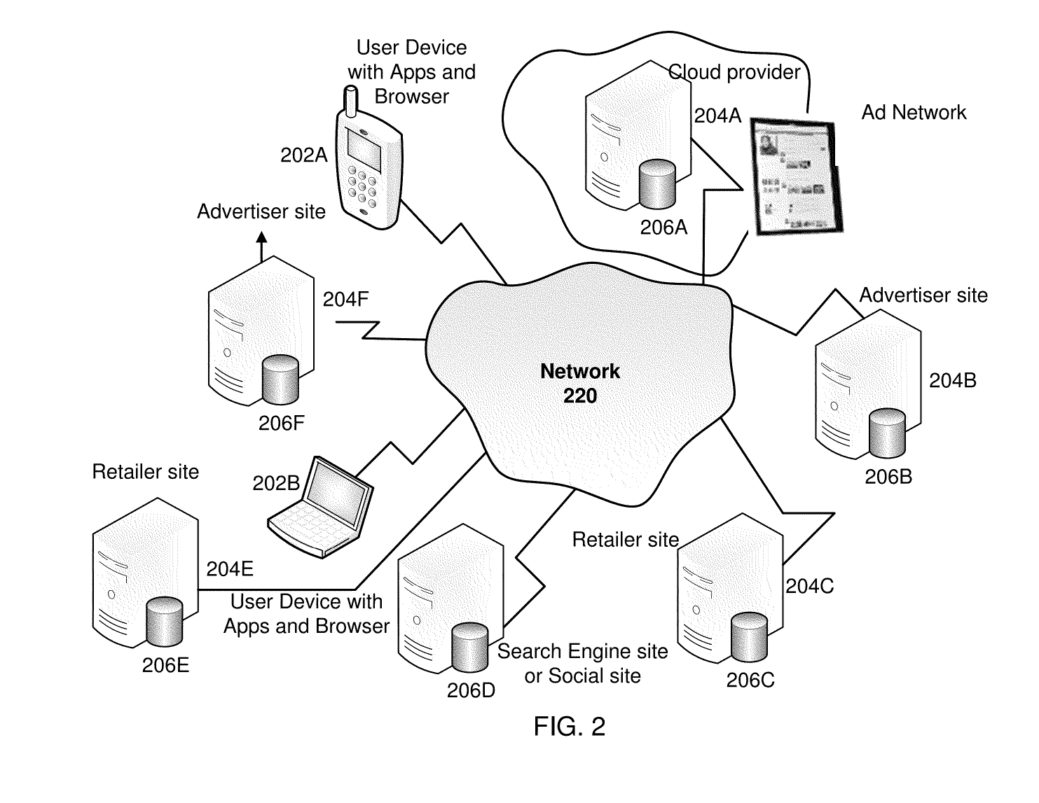

Example processes for and apparatuses to provide the Ad network are described. The following drawings and text describe various example implementations of the design. FIG. 1 and FIG. 2 illustrate example environments to implement the concepts.

FIG. 2 illustrates a block diagram of an embodiment of the Ad network and its aspects like real time bidding and optimization of video ads for organic and paid media. In an embodiment, the online Ad network aids in connecting advertisers to web sites that want to host or publish advertisements. The online Ad networks may use one or more Ad servers to deliver advertisements as downloaded content to consumers on a client device, which enables targeting of advertisements to a specific group of consumers. The Ad server can be a computer server, specifically a web server backed by a database server, that stores advertisements used in online marketing and delivers them to website visitors. The content of the webserver is constantly updated from the sites of the customers. The multiple PVAs are indexed and stored in a database that cooperates with the Ad server. A library in a database stores and indexes the PVAs. The Ad network is configured with one or more user interfaces to allow real time bidding by multiple advertisers. The Ad network may utilize a network flow analyzer to assist in traffic reporting. The Ad network may employ Ad serving technology to provide software to web sites and advertisers to serve advertisements including the PVAs, count them, choose the ads that will make the website or advertiser most money, and monitor progress of different advertising campaigns. The list of the online advertising space that the Ad network may deliver advertisements to includes space on websites, in RSS feeds, on blogs, in instant messaging applications, in adware, in e-mails, and on other sources.

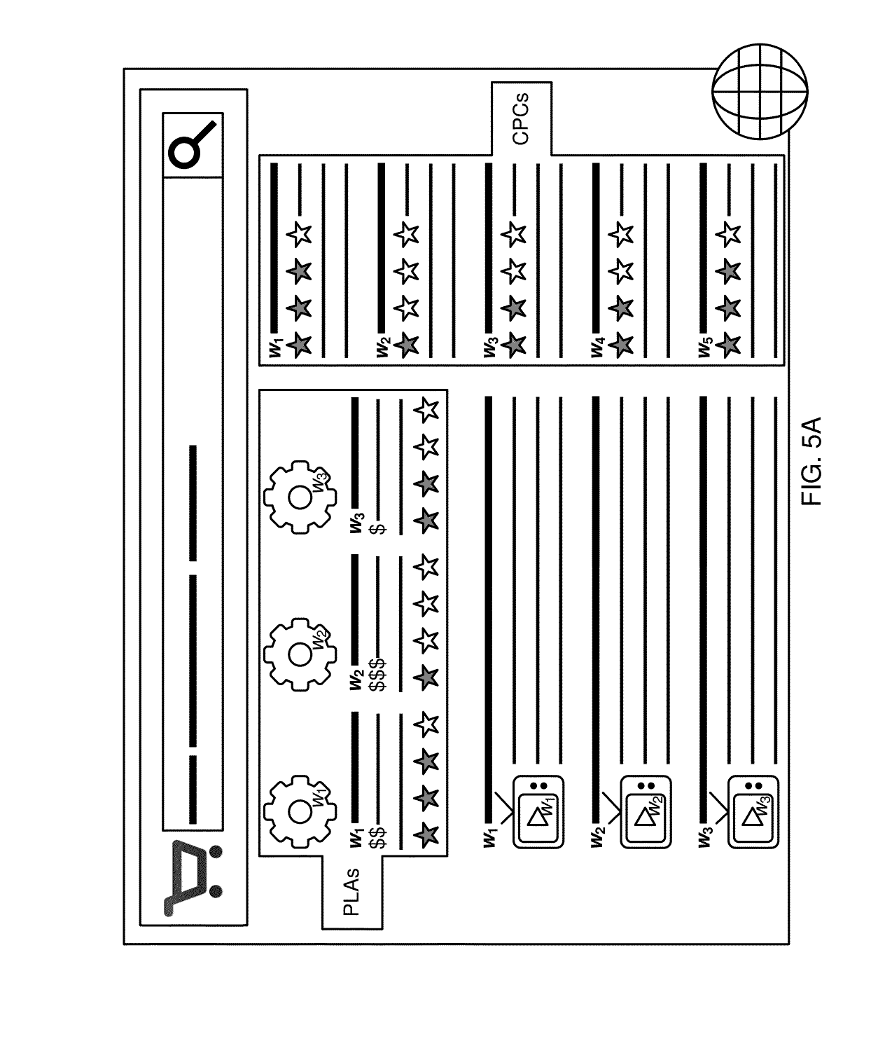

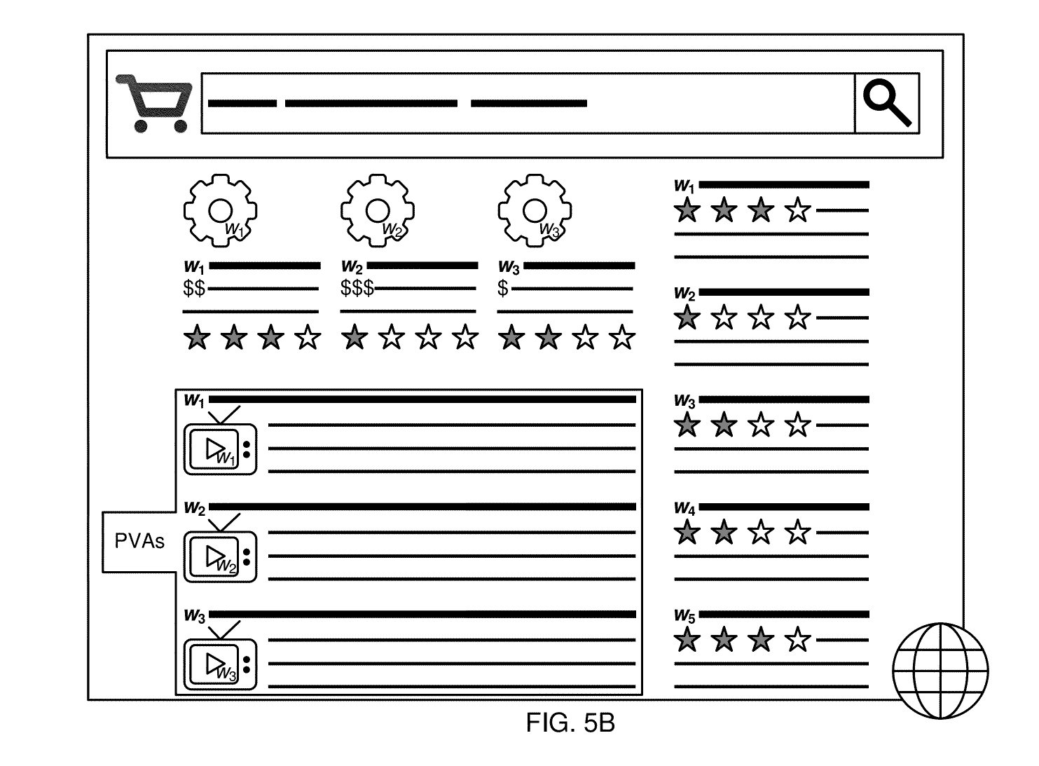

The Ad network is a performance CPC and/or CPA Ad network that utilizes proprietary ad units—the PVAs. (See, for example, FIG. 5B.) The PVAs drive qualified customers on a client device to a plurality of advertiser's websites. The PVA units are a perfect blend of Organic and Paid Search. As discussed in more detail later, PVA units give short video summaries that gain high organic ranking while also providing effective, high-conversion content for social, mobile, search and display ad campaigns.

The Ad network is configured to use search engine optimization to affect the visibility of the PVAs in a search engine's “natural” or un-paid (“organic”) search results. In general, the earlier (or higher ranked on the search results page), and the more frequently a site appears in the search results list, the more visitors that on-line site will receive from the search engine's users. The search engine may be associated with a search engine website, a social site, or other on-line platform.

The Ad network directs qualified customers on a client device to a merchant's on-line store or website. In order to deliver on an advertiser's campaign goals, the Ad network and resulting organic videos must: (1) generate high organic search listings to be discovered by users searching on-line for keyword terms related to product or targeted effectively in paid media, (2) after clicking on the PVA, produce engaging content for the user to watch the entire video, and (3) at the end of the video, convince the user to click thru to the merchant site.

The Ad network is built and configured to use a combination of both free organic traffic (vis a vis top listings on a search page) as well as paid traffic in any Ad network. In an embodiment, the Ad network is also configured to optimize each Ad campaign and delivers clicks based upon real time bidding by advertisers, matching qualified shoppers to advertisers who don't necessarily pay the most, but where the Ad network can earn the largest spread between buying the click and selling to advertiser.

### Organic Media

Users on client devices, including customers, can discover the PVAs while conducting searches on an on-line website such as Google, YouTube, Bing, Yahoo, etc. The PVAs are generally listed in top portion of the organic search rankings. In fact, when people search in Google, video results are up to 50× more likely than text to appear in the top slots based upon Google's current algorithms. Users on client devices are also 7× more likely to click on video links in organic search listings than any other text links/ads on the page. After a user watches a PVA displayed on the display screen of their client device, the PVA is configured to present a link for the user on the client device to have the opportunity to click thru to one or more advertisers' website where they enter as a highly qualified prospect.

The Ad network increases a customer's search visibility in organic listings. Search advertisers have previously had two choices: PLAs (effective & expensive) or text PPC ads (less effective & cheap) to advertise on SERPs. The Ad network offers a new organic listing option that's more effective than existing options at competitive keyword prices. Just as the advertiser currently buys shopping ads and text ads, the PVAs allow advertisers to occupy more listings in the returned search results to increase product discovery. Because the first page of search is like valuable real estate, the more property an advertiser can occupy, the more likely customers searching for its products will discover them. Our network of advertisers could expect to see on average a 4× increase in the number of spots they occupy on the first page of search. Finally, the more spots an advertiser can occupy on the first page of search means the less room there is for their competitors' listings.

The Ad network is built and configured with search engine optimization algorithms to get advertisers listed high in a search engine results page. A search engine result page is the listing of results returned by a search engine, typically, in response to a keyword query. The results normally include a list of items with titles, a reference to the full version, and a short description showing where the keywords have matched content within the page. Search engine result pages of major search engines like Google, Yahoo!, and Bing, may include different types of listings: contextual, organic search listings (or algorithmic), as well as paid sponsored listings. Organic search engine result page listings are the natural listings generated by search engines based on a series of metrics that determines their relevance to the searched term. Relevant media, such as webpages, articles, and the PVAs, that score well on a search engine's algorithmic test show in this list on the page. These algorithms are generally based upon factors such as the content of a webpage, the trustworthiness of the website, and external factors. Each page of search engine results contains a set number of organic listings, such as 10 listings. The listings, which are on the first page are the most important ones, because, for example, those on the first page can get 90% of the CTRs from a particular search. Paid search engine result page listings, as opposed to Organic listings, are advertisements, or sponsored links, included by search engines in their search results. Websites pay search engines to have their web pages listed here on this section of the returned search engine result page.

Note a search query is the word, set of words, image and/or combinations of these that are typed by the user in the search bar of the search engine. Most of the time this search string is one or more keywords.

Paid Media (Paid Downloadable Content that Will Appear and be Displayed on a Display Screen of a User's Device)

As discussed, the Ad network is built and configured to also deliver PVAs into browsers and into the most popular apps like Facebook and Twitter as a standard ad unit. The Ad network is built and configured to optimize media buys to deliver performance metrics that advertisers are seeking (typically on CPC or CPA basis). The Ad network allows for geographic and demographic targeting based upon user behavior. The Ad network buys impressions on a per spot basis on behalf of advertiser and then adjusts the bid in accordance with an advertiser's goals. The Ad network optimizes the spending in real time and automatically adjusts the spot bid to meet advertiser's goals.

### Paid+Organic Combined

The Ad network is built and configured to use a combination of both free organic traffic (vis a vis top listings on a search page) as well as paid traffic in any Ad network. This provides three distinct advantages for the Ad network: (1) Through the “signal” data collected in organic search listings, the Ad network accurately predicts which products or keywords are receiving the most interest in any given moment. This data acts as a signal to the Ad network and predicts demand around the product or service that the PVA is associated with; and (2) with this signaling data, the Ad network can initiate media buys on behalf of advertiser to deliver traffic on a CPC or CPA basis; and (3) the amount that the Ad network may bid for media is more competitive than other bids due to the Ad network's ability to deliver organic traffic at a zero cost basis; thus, lowering the cost of the overall campaign. The true cost of media for the Ad network is equal to the weighted average sum of the cost of organic plus paid media divided by the number of actions (click, impression, action) delivered to advertiser.

For example:
Where organic media delivers a cost of $0.00 per click and delivers 1000 clicks; and
Where paid media delivers a cost of $0.50 per click and delivers 1000 clicks; and
Where, the media campaign delivers 2000 total clicks:

$$Then \text{:} \frac{( Organic CPC \times \# Clicks ) + ( Paid CPC \times \# Clicks )}{\# of Total Clicks}$$

$$True CPC \text{:} \frac{( \$0 \times 1000 ) + ( \$0 .50 \times 1000 )}{2000} = \$0 .25 CPC$$

Thus, the Ad network is configured to deliver performance marketing solutions, typically thru cost per click or cost per acquisition, to advertisers seeking to find qualified shoppers online. Advertisers are able to more effectively target consumers compared with traditional search ads and consumers get a visual way to discover and research products on whatever device they use. The core of the Ad network is a proprietary PVA unit,—short video advertorials that engage consumers and deliver qualified shoppers to advertisers. The Ad network uses a data optimization technology platform to deliver the PVAs thru organic and paid media resulting in leading performance metrics (CPC/CPA) for advertisers. With the technology platform and presenter network for the Ad network, the Ad network can produce, traffic and optimize videos at scale for millions of products and services.

The Ad network is also configured to create and provide Click to Call in PVA units. The Ad network helps brands tap into the mobile tidal wave by allowing click to call capability directly in these PVA units. The Ad network makes and provides and then stores organic videos with a Click-to-Call option for all customers. This means shoppers using smartphones or tablets can, after watching a short PVA, tap an onscreen link that will launch their phone app and dial a phone number. It works on desktop and laptop computers as well for users who have a VoIP program installed (like Skype). The Click to Call in Video Ad Unit downloaded into the user's device has a routine configured to search for and cooperate with a VoIP program installed on the client's device. Now brands can run our high-performing video ad units across all platforms and drive traffic to their websites and their call centers.

The Ad network is the first to enable click to call capability directly in the video ad unit. This feature configured into the PVAs helps brands tap into the mobile tidal wave by allowing click to call capability directly in the PVAs. Thus, the Ad network makes and provides organic videos with a Click-to-Call option for all customers in order to allow shoppers using smartphones or tablets to tap an onscreen link that will launch their phone app and dial a phone number after watching a short PVA.

The Ad network is built from the ground up to optimize advertising campaigns for the mobile visual Internet. The Ad network creates short (30 second), engaging PVAs that are trafficked in organic (e.g. Google, Bing, YouTube) and paid media (e.g. Facebook, Twitter, Pinterest). The Ad network's proprietary video that incorporate search engine optimizations into the content and metadata of the videos to cause the videos to surface organically in search engine result pages. The Ad network also buys traffic programmatically from other networks to boost margins and meet advertiser performance goals. The anticipated results speak for themselves: the average CTR of the Ad network (9%) outperforms Google's most effective ads by more than 3× based on data.

Traditional search advertising increasingly underperforms now that 60% of all web traffic happens on mobile devices. Only 1 in 7 people on mobile devices even use a browser on a mobile device, so advertisers are wasting as much as half their search marketing spend in traditional paid search. They need new options that reach mobile shoppers who may never see a Google/Bing search ad.

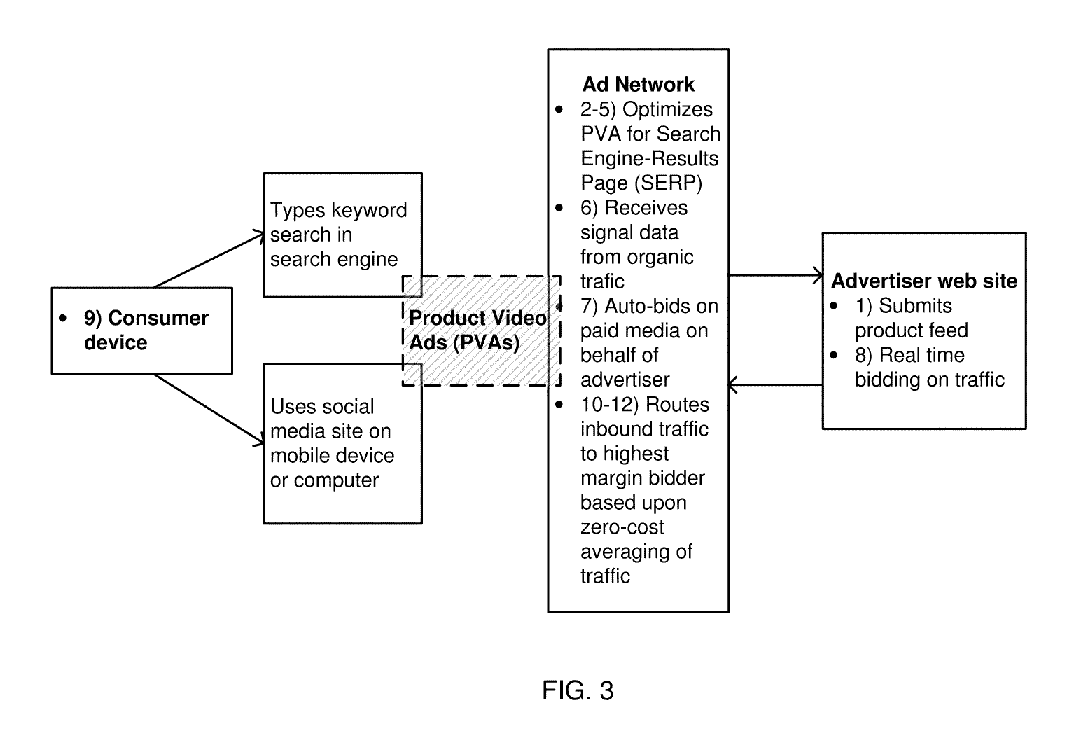

FIG. 3 illustrates one example embodiment of the sequence of steps that occurs in the Ad network.

First, the advertiser submits a product data feed into the Ad network database via one or more RSS feeds and/or user interfaces. The Ad network parses the product data feed to identify and index key points.

Second, the Ad network scans available content found online regarding the products.

Third, the Ad network dynamically creates PVAs based upon the product data and the content found online.

Fourth, the Advertiser approves the PVAs and then the Ad network publishes the PVAs.

Fifth, the Ad network optimizes the video to index organically into search engine result pages.

Sixth, the Ad network receives data “signals” from organic PVAs which indicate which PVAs (and hence products) are receiving the highest interest and begins placing spot bids on media to display the PVA in paid traffic.

Seventh, the selected PVAs run in paid media and are optimized to get to the lowest cost value possible. The Ad network automatically bids on paid media on behalf of advertiser.

Eight, advertisers use the Ad network to bid in real time for the traffic/clicks/actions associated with each PVA.

Ninth, the user either (1) types a keyword search into a browser based search engine; or (2) is interacting with an application via mobile device, and sees a PVA link (thumbnail image with a play button).

Tenth, the user on a client device clicks on the PVA and is directed to a video hosted on the Ad network platform or elsewhere.

Eleventh, at the completion of the video, user can also click on call to action button (“Get the Best Price Now”).

Twelfth, the user is sent to the Ad network where we route the traffic to the appropriate advertiser based upon the largest margin between any given advertisers' maximum bid and the cost to secure the click in real time. The Ad network routes inbound traffic to highest margin bidder based upon zero cost averaging of traffic.

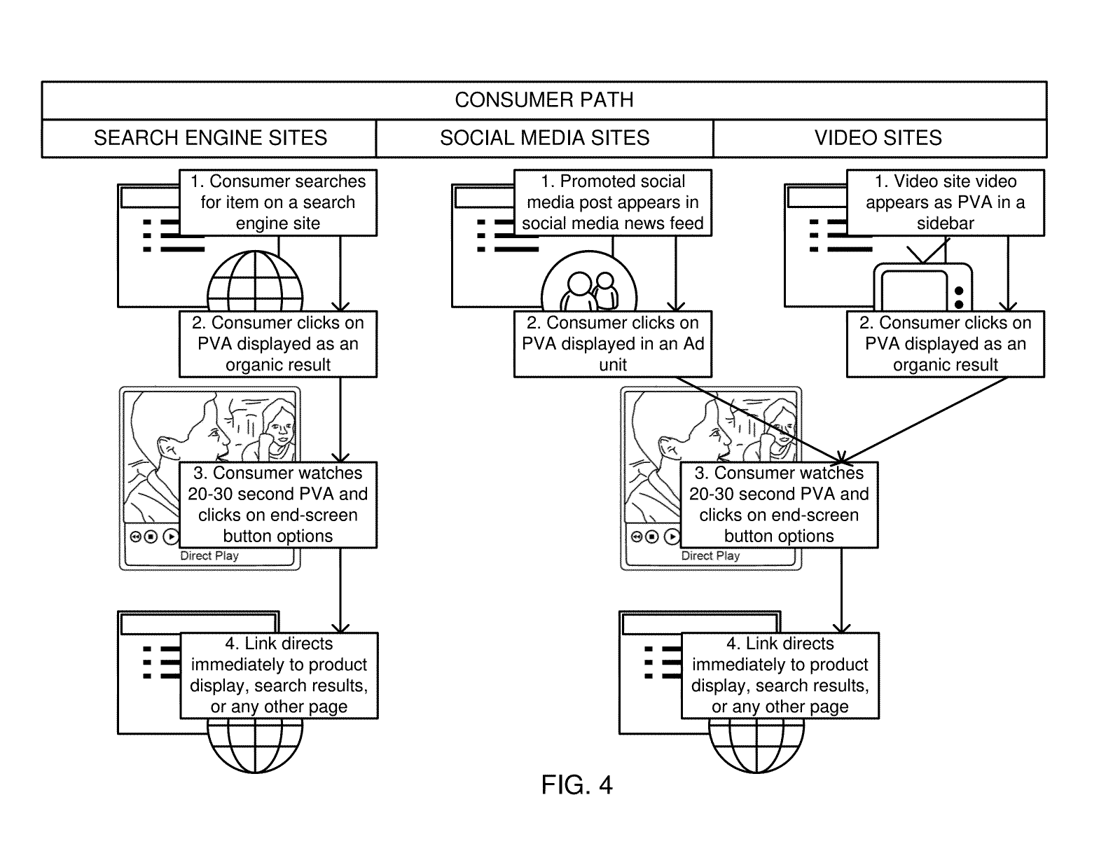

FIG. 4 illustrates the Ad network from a perspective of a consumer on a client device, in accordance with some embodiments. The consumer can engage the Ad network on any of a number consumer paths starting from any one or more search engine sites, social media sites, or video sites to name a few sites.

With respect to a search engine site, for example, the consumer can search for an item (e.g., retail product or service) on the search engine site. As shown in either FIG. 5A or FIG. 5B, the consumer can be presented with a number of PVAs for the item (e.g., a first PVA for a first widget w₁, a second PVA for a second widget w₂, a third PVA for a third widget w₃, etc.), which PVAs are displayed as organic search results. Upon selecting (e.g., clicking on) a PVA, the consumer can watch the PVA, which may encompass a 20-30 second video about the searched item or a related item. As provided herein, the Ad network can provide embedded links in the PVAs, which embedded links can show up as one or more end-screen or end-PVA options (e.g., clickable button options). Upon selecting an end-screen option, the consumer can be directed by the Ad network to any of a number of on-lines sites such as a product display by an advertiser or retailer, search results, or any other page.

With respect to a social media site, for example, the consumer can find an item (e.g., retail product or service) while scrolling through a news feed on the social media site. The item can be promoted in the consumer's news feed, and the item can appear as a PVA in the consumer's news feed. Upon selecting (e.g., clicking on) the PVA, the consumer can watch the PVA, select an end-screen option, and visit any of a number of on-lines sites per the Ad network's one or more embedded links in the PVA.

With respect to a video site, for example, the consumer can find an item (e.g., retail product or service) or a PVA therefor in a sidebar of the video site or subsequent to playing a video. Upon selecting (e.g., clicking on) the PVA, the consumer can watch the PVA, select an end-screen option, and visit any of a number of on-lines sites per the Ad network's one or more embedded links in the PVA.

Each figure of FIG. 5A and FIG. 5B illustrates search results in a search engine-results page, in accordance with some embodiments. The search results can be organic search results or paid search results. For example, FIG. 5A identifies PLAs for a number of widgets (e.g., retail products or services) represented by a first PLA for a first widget w₁, a second PLA for a second widget w₂, and a third PLA for a third widget w₃. FIG. 5A also identifies CPCs for the number of widgets represented by a first CPC for the first widget w₁, a second CPC for the second widget w₂, and a third CPC for a third widget w₃. FIG. 5B identifies PVAs for the number of widgets represented by a first PVA for the first widget w₁, a second PVA for the second widget w₂, and a third PVA for a third widget w₃.

### Product Data Integration

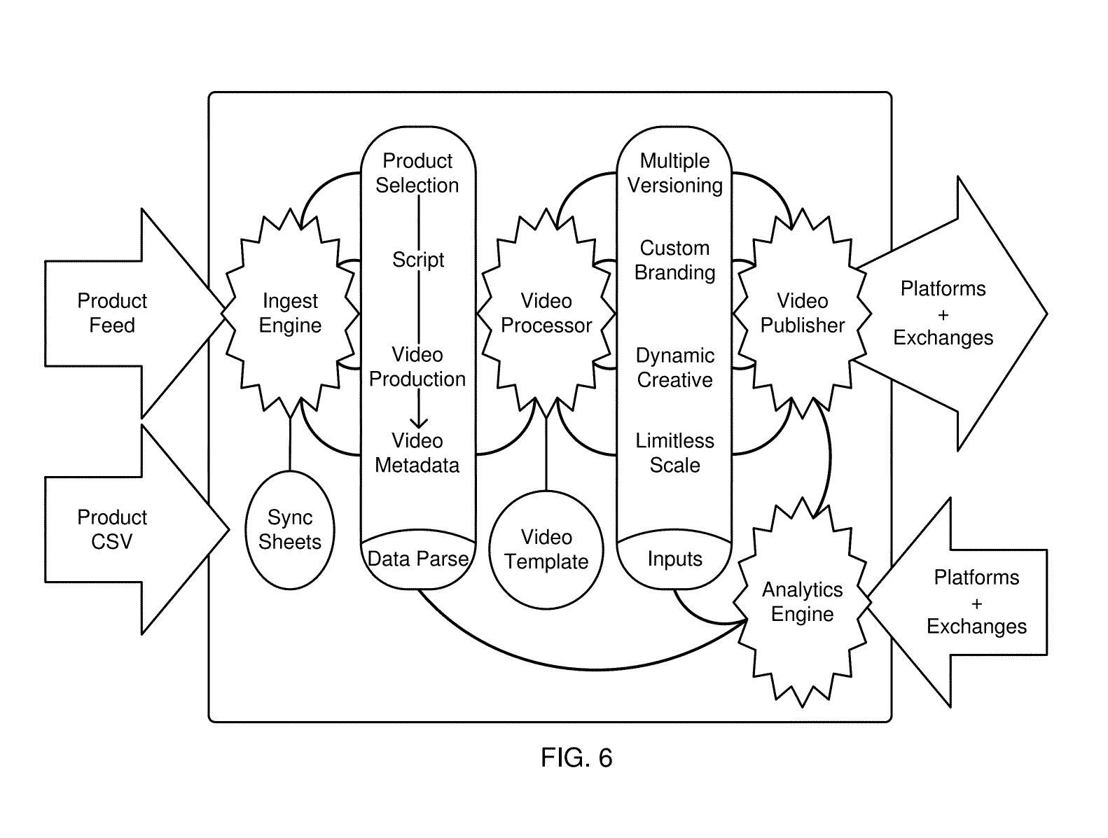

Some process steps that the Ad network is configured to take are as follows. A customer will provide the Ad network information on the products the customer would like to get started with and the Ad network will create PVAs. Creation of PVAs can be automated as illustrated in FIG. 6, which illustrates an automated PVA platform cooperating with the Ad network, in accordance with some embodiments. An advertiser can submit a Rich Site Summary (RSS) feed (e.g., Product Feed as shown in FIG. 6) to deliver product data to the Ad network, including images, product descriptions, and pricing. The Rich Site Summary can be a web feed format to publish frequently updated information: blog entries, news headlines, audio, video, etc. A web feed is an RSS document that includes full or summarized text, and metadata, like publishing date and author's name so publishers can syndicate data automatically. A standard XML file format ensures compatibility with many different machines/programs. The Ad network may also have one or more user interfaces to acquire information (e.g., Product CSV as shown in FIG. 6) on the products from the customer. The Ad network creates the link processing and integration into the network's video library stored in a database that cooperates with the one or more Ad servers.

### Automated PVA Platform

FIG. 6 illustrates an automated PVA platform cooperating with the Ad network, in accordance with some embodiments. As provided herein, retail product or service data can be integrated into such an automated PVA platform. As illustrated in FIG. 6, for example, an Ingest Engine can be configured to receive a Product Feed and/or a Product CSV via Sync Sheets. By way of the retail product or service data ingested by the Ingest Engine, the automated PVA platform can be configured to select for a video processor (e.g., Video Processor) a retail product or service (e.g., Product Selection), a script (e.g., Script), and parsed data (e.g., Data Parse), which data originates from a number of platforms and exchanges (e.g., Platforms+Exchanges) via an analytics engine (e.g., Analytics Engine). The video processor can then create any of a number of PVA for publishing by a video publisher (e.g., Video Publisher).

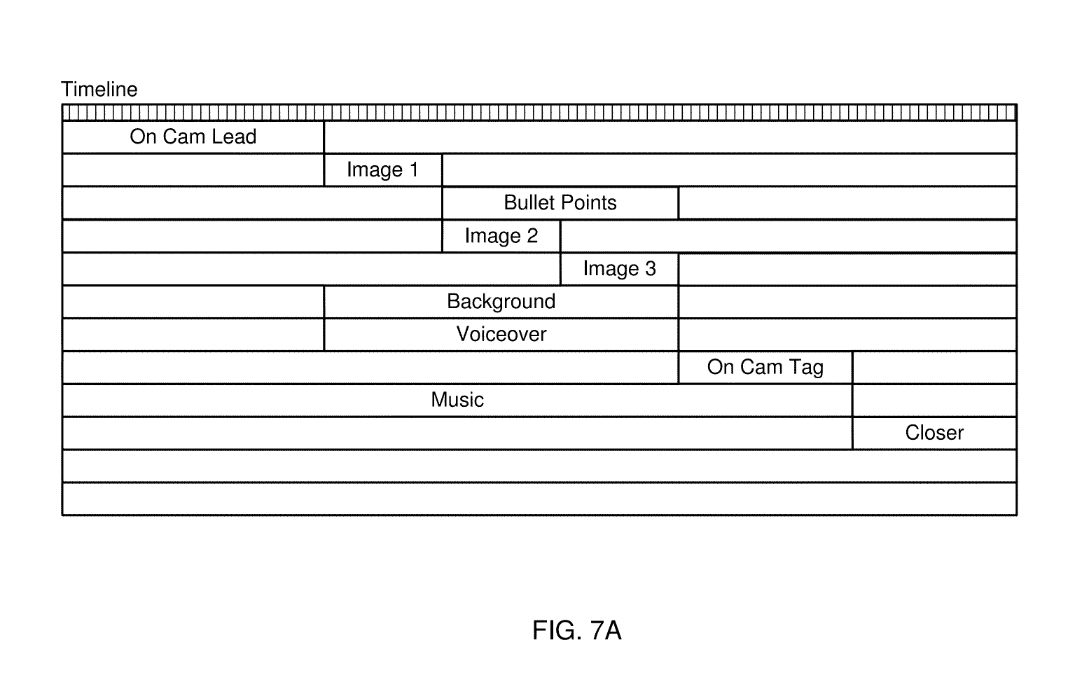

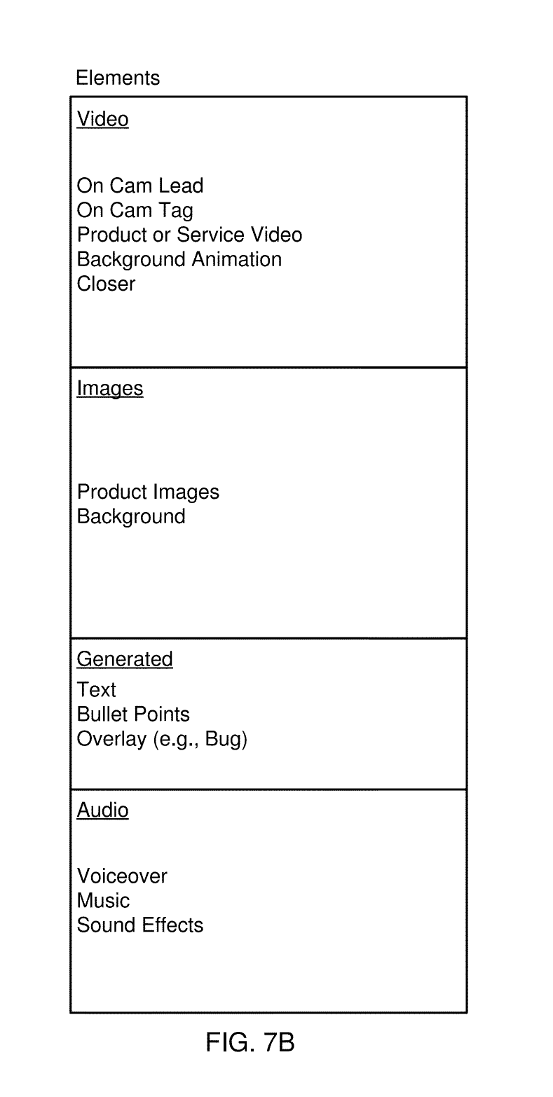

The video processor of FIG. 6 can be configured to incorporate a video template built by an operator (e.g., a retailer or an advertiser) for an unlimited number of PVAs. FIG. 7A illustrates a video processor timeline for a PVA or a template therfor, in accordance with some embodiments. FIG. 7B illustrates elements for the video processor timeline of FIG. 7A, in accordance with some embodiments. As shown in FIG. 7B, elements for the video processor timeline include video elements including On Cam Lead, On Cam Tag, Product or Service Video, Background Animation, and Closer; image elements including Product Images and Background; generated elements including Text, Bullet Points, and Overlay; and audio elements including Voiceover, Music, and Sound Effects. Any one or more of the elements shown in FIG. 7B can be placed in the video processor timeline as exemplified by the video processor timeline of FIG. 7B. As provided herein, the video processor can then create any of a number of PVA for publishing by a video publisher (e.g., Video Publisher).

### Content Scans and Sentiment Analysis Algorithms

The Ad network is configured to acquire content scans and use sentiment analysis algorithms. At this point, the Ad network uses, for example, a bot network or similar mechanism, to scan thousands of online reviews regarding the products and applies sentiment analysis algorithms to find the most common attributes of the product or service. The Ad network then is configured to apply routines to turn that data into useable information by allowing our presenters to create personal, powerful video reports summarizing the favorable sentiment around products or services. The thousands of scans will produce lists of common sentiments around the products or services. By tapping into the mass of existing reviews about the product, merchants then do not need to hassle with (1) the exchange and managing of product samples and reviewers, and (2) convincing existing customers to record themselves giving reviews of the product. By utilizing existing publicly available content and turning it into short videos that users desire, the Ad network can create multiple PVAs very quickly across an entire catalog and produce Return on Investment (ROI) for our merchants in a short period. The multiple PVAs are indexed and stored in a database that cooperates with the Ad server. The general availability of more data around behavior for specific users will enable the Ad network to better target and optimize campaigns for users.

### Real Time Bidding by Multiple Advertisers

The Ad network is configured with one or more user interfaces to allow real time bidding by multiple advertisers. Thus, the Ad network is able to allow multiple advertisers to bid in real time for the clicks from user's devices associated with each PVA. When an advertiser logs into their advertiser account stored and provided by the Ad network, a screen allows the advertiser to adjust the bid price on each PVA. After a user clicks the call to action button at the end of the video, the user is sent to the Ad network to determine which advertiser to re-route the traffic to. If the PVA is non-exclusive to any particular advertiser, the Ad network will automatically redirect the click to the bidder that generates the highest margin, or “spread,” for the network. The Ad network can use an algorithm to determine whether the current bid from an advertiser is greater than what it would cost for the network to acquire the click; and if so, will automatically purchase the click at the lower value and sell the click to advertiser willing to pay the higher value. Because a portion of the overall traffic to any advertiser will include zero cost clicks from organic search, the network can place higher value bets on bid prices with the knowledge that its cost basis will on average be lower than any other bidders who do not utilize zero cost traffic. The determination of the highest margin bidder and re-routing of traffic occurs instantaneously for user. Real time bidding by multiple advertisers may in essence exclude competition so users do not see competitors' websites but are merely directed to the winning advertiser's desired site.

### Network Flow Analyzer

The Ad network may utilize a network flow analyzer to assist in traffic reporting. The Ad network provides real time traffic reports to the advertiser with analytics and details around the campaign. On average PVAs provided by the Ad network may see a significant increase, such as four times as much, click thru rate to the merchant site, compared with existing search ads. In addition to the higher click through rate, the quality of the clicks are much higher since someone who watches a review video and then clicks through is much more serious with regards to purchase intent than someone who just clicks on a sponsored link without any context of whether the product can meet their needs. The Ad network does provide analytics. The Ad network offers a detailed set of analytics that allow clients to gain insight into how users interact with their campaigns and products. The Ad network may perform various other tasks like counting the number of impressions/clicks for an ad campaign and report generation, which helps in determining the ROI for an advertiser on a particular website. The Ad servers can serve ads across domains owned by multiple publishers. They deliver the ads from one or more databases, but still are treated as a central source, so that advertisers and publishers can track the distribution of their online advertisements, and have one location for controlling the rotation and distribution of their advertisements across the web.

### Price Estimation and Control

The Ad network creates a competitive CPC or CPA rate using the data gathered from an initial 30 day traffic test to charge the advertiser. This is also the suggested minimum-bidding price if the advertiser is bidding on the PVA. The Ad network can base the CPC rate for each click made on the PVA by users on their client device on the blended average of Google's suggested bidding price from Adwords' Keyword Planner tool for products/keywords as well as other factors. Finally, the Ad network provides a routine and displayed screen where merchants can easily set their monthly budget/# of clicks by capping the amount of paid search they desire on the Ad network.

### PVAs are Complementary to Existing Search Marketing Programs

The Ad network is configured to not directly compete with any existing Google AdWords campaigns. The Ad network and resulting organic videos are complimentary to a merchant's existing Shopping Ad (PLA) and PPC text ad buys. PLAs and text ads are great in that they give advertisers real estate on the top, bottom, and right bar of a search results page returned by a search engine. The Ad network and resulting organic videos put the existing real estate on the left and center of the search page—the organic results—into play for an advertiser. As such, Ad network and resulting organic videos are additive and increase the odds that would-be customers will find a merchant's site and be directed to relevant portions of an advertiser's site. As PLA prices escalate, it makes sense to supplement advertisers' paid search strategy and grab additional real estate a search engine's results page to help boost traffic. In fact, the Ad network and resulting organic videos effectively gives an advertiser the same premium placement as PLAs (center page) but at CPC rates on par with text ad buys.

The PVAs complement existing organic links put out by potential customers. On numerous occasions, the PVA links outrank even Amazon's product links so it is likely that the PVAs sometimes rank higher than some of the customer's own product links. However, this is no different from what exists today when your competitors are working day and night to outrank your links. With the PVAs from the Ad network, you can capture that space and use it to redirect shoppers to your store. Again, owning more property in search listings on a search engine's results page can only benefit you.

As discussed, in an embodiment, the online Ad network aids in connecting advertisers to web sites that want to host advertisements. The online Ad networks may use one or more Ad servers to deliver advertisements as downloaded content to consumers on a client device, which enables targeting of advertisements to a specific group of consumers. The Ad server can be a computer server, specifically a web server backed by a database server, that stores advertisements used in online marketing and delivers them to website visitors. The content of the webserver is constantly updated so that the website or webpage on which the ads are displayed contains the latest and new advertisements—e.g., PVAs, banners (static images/animations) or text—when the site or page is visited or refreshed by a user. A purpose of ad serving can be to deliver ads to users, to manage a websites advertising space and (in the case of advertiser Ad servers) to provide an independent counting and tracking system for advertisers. The Ad network may employ Ad serving technology to provide software to web sites and advertisers to serve ads, count them, choose the ads that will make the website or advertiser most money, and monitor progress of different advertising campaigns. The list of online advertising space that the Ad network may deliver advertisements to includes space on websites, in RSS feeds, on blogs, in instant messaging applications, in adware, in e-mails, and on other sources. Note, the Ad network via cooperation with ad exchanges allows the Ad network to plug into multiple sources of inventory and traffic for its ads. Also, as bandwidth available for user devices increases and video adoption rises, ‘flat image’ shopping will be replaced by visual ad units, with PVAs leading the way.

The PVAs are hosted on the Ad network in order to receive the full SEO insertions and modifications that produce top search rank results. The Ad network is a Google/YouTube partner and this allows the Ad network exclusive access to Partner tools and reporting that the Ad network then can use to benefit our merchant network. The PVAs may be hosted and discovered in social channels including YouTube, Google, Facebook, Twitter, etc. The Ad network's proprietary algorithms ensure that the network maximizes organic search results for your products in search, social, and video search. While PVAs are hosted primarily on our Ad network, some merchants also place PVAs on their own site and product pages to help with onsite conversion and further increase search visibility.

The Ad network charges a one-time per video set up fee and then provides 30 days of free organic traffic. Following the free period clients choose a CPC or CPA contract, terms of which are based upon publicly available rates. Based upon current unit economics, the lifetime value of each PVA is 3× the cost of acquiring the client and creating the video. This model is highly scalable considering the continued growth of e-Commerce where each product will require video content to replace traditional “flat image” shopping in the mobile era.

Traditional search engine websites, such as Google, dominate search advertising but retailers are rapidly increasing their spending in other media spaces such as in social sites like Facebook. The Ad network both competes and cooperates with these players for ad budgets but also relies on them for traffic. The Ad network's unique advantage is that our network delivers performance with a combination of ‘zero cost’ organic traffic and highly optimized paid media traffic. This free+paid traffic model allows us to purchase qualified traffic at a lower cost basis than previously available to advertisers, which ultimately results in higher performance for them and higher margins for the Ad network. Furthermore, the Ad network has a system by which advertisers can bid, optimize, and track media spend across combined organic and paid media.

Overall, an aspect of the Ad network is the use of a combination of both free organic traffic (vis a vis top listings on a search page) as well as paid traffic in any Ad network. This provides three distinct advantages for the Ad network: (1) Through the “signal” data collected in organic search listings, the Ad network accurately predicts which products or keywords are receiving the most interest in any given moment. This data acts as a signal to the Ad network and predicts demand around the product or service that the PVA is associated with; and (2) with this signaling data, the Ad network can initiate media buys on behalf of advertiser to deliver traffic on a CPC or CPA basis; and (3) the amount that the Ad network may bid for media is more competitive than other bids due to the Ad network's ability to deliver organic traffic at a zero cost basis, thus lowering the cost of the overall campaign. The true cost of media for the Ad network is equal to the weighted average sum of the cost of organic plus paid media divided by the number of actions (click, impression, action) delivered to advertiser.

Customers may put their logo or brand on the videos. The Ad network is configured to create PVAs that allow for image and other metadata overlays, for example a company's logo or brand to be displayed on the videos. We generally find that a product image overlay while a customer is reviewing is the best way to get your point across. The Ad network is configured to make and provide organic videos that have a link that may direct the browser or application of a mobile device viewing the organic video directly to the relevant retailer's website that offers similar products to those viewed by the user of the mobile device when watching the organic video.

The PVAs are 20-30 seconds long and immediately get to what shoppers want to know: what do customers think about a product. Short form video content is more effective in giving consumers the information they are seeking and much more consumable on mobile devices where visual communication has largely replaced writing and reading long documents like reviews. An embodiment of the PVA can be found in U.S. Patent Application No. 61/697,364, which application is incorporated herein by reference in its entirety, and which includes the additional details on the exclusive method by which advertisers can create, manage, and publish PVAs for its products.

The Ad network may create, index and store several PVA videos per product.

The exact amount depends on a few things. First, how many existing competing videos are there for that particular product? The Ad network likes to create enough videos to saturate the pool of videos and ensure that we maximize search optimization. For top products with multiple reviews, a given product could have up to twenty product review videos driving traffic to an advertiser's site. Just imagine having tens of thousands of video review summaries floating in cyberspace and receiving top search rankings, all driving traffic to all of the products included in your on-line store. Best of all since videos are organically indexed to the top of search you will essentially find that you are getting placement without the need to bid on high priced keywords!

Note, contextual advertising may be used by search engines to display advertisements on their search results pages based on the keywords in the user's query and the Ad network is configured to make PVAs that can take advantage of this fact. Contextual advertising is a form of targeted advertising in which the content of an ad is in direct correlation to the content of the web page the user is viewing or key words submitted in the user's query. For example, if you are visiting a website concerning travelling in Europe and see that an ad pops up offering a special price on a flight to Italy, that's contextual advertising.

The Ad network operates as a third party Ad network so there is no need to integrate your technology to ours. The Ad network's advertisements work with any web browser, operating system, or mobile app. The Ad network's advertisements have been formatted to a have a series of versions of the advertisement, tested on every platform, configuration for a great user experience, and is mobile optimized for all platforms.

### Computing System

FIG. 1 illustrates a block diagram of an example computing system that may be used in an embodiment of one or more of the servers and client devices discussed herein. The computing system environment 800 is only one example of a suitable computing environment, such as a client device, server, ad network electronic module, etc., and is not intended to suggest any limitation as to the scope of use or functionality of the design of the computing system 810. Neither should the computing environment 800 be interpreted as having any dependency or requirement relating to any one or combination of components illustrated in the exemplary operating environment 800.

With reference to FIG. 1, components of the computing system 810 may include, but are not limited to, a processing unit 820 having one or more processing cores, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing system 810 typically includes a variety of computing machine-readable media. Computing machine-readable media can be any available media that can be accessed by computing system 810 and includes both volatile and nonvolatile media, removable and non-removable media. By way of example, and not limitation, computing machine-readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computing device 800. However, carrier waves would not fall into a computer readable medium. Communication media typically embodies computer readable instructions, data structures, program modules, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computing system 810, such as during start-up, is typically stored in ROM 831. RAM 832 typically contains data and/or program modules that are immediately accessible to and/or presently being operated on by processing unit 820. By way of example, and not limitation, FIG. 1 illustrates operating system 834, program modules 836, and program data 837.

The computing system 810 may also include other removable/non-removable volatile/nonvolatile computer storage media. By way of example only, FIG. 1 illustrates a hard disk drive 841 that reads from or writes to non-removable, nonvolatile magnetic media nonvolatile optical disk 856 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 1, provide storage of computer readable instructions, data structures, program modules and other data for the computing system 810. In FIG. 1, for example, hard disk drive 841 is illustrated as storing operating system 844, program modules 846, and program data 847. Note that these components can either be the same as or different from operating system 834, program modules 836, and program data 837. Operating system 844, program modules 846, and program data 847 are given different numbers here to illustrate that, at a minimum, they are different copies.

A user may enter commands and information into the computing system 810 through input devices such as a keyboard 862, a microphone 863, a pointing device 861, such as a mouse, trackball or touch pad. The microphone 863 may cooperate with speech recognition software. These and other input devices are often connected to the processing unit 820 through a user input interface 860 that is coupled to the system bus, but may be connected by other interface and bus structures, such as a parallel port, game port or a universal serial bus (USB). A display monitor 891 or other type of display screen device is also connected to the system bus 821 via an interface, such as a video interface 890. In addition to the monitor, computing devices may also include other peripheral output devices such as speakers 897 and other output device 896, which may be connected through an output peripheral interface 890.

The computing system 810 may operate in a networked environment using logical connections to one or more remote computers/client devices, such as a remote computing device 880. The remote computing device 880 may be a personal computer, a hand-held device, a server, a router, a network PC, a peer device or other common network node, and typically includes many or all of the elements described above relative to the computing system 810. The logical connections depicted in FIG. 1 include a local area network (LAN) 871 and a wide area network (WAN) 873, but may also include other networks. Such networking environments are commonplace in offices, enterprise-wide computer networks, intranets and the Internet. A browser application may be resident on the computing device and stored in the memory.

When used in a LAN networking environment, the computing system 810 is connected to the LAN 871 through a network interface or adapter 870. When used in a WAN networking environment, the computing system 810 typically includes a modem 872 or other means for establishing communications over the WAN 873, such as the Internet. The modem 872, which may be internal or external, may be connected to the system bus 821 via the user-input interface 860, or other appropriate mechanism. In a networked environment, program modules depicted relative to the computing system 810, or portions thereof, may be stored in the remote memory storage device. By way of example, and not limitation, FIG. 1 illustrates remote application programs 885 as residing on remote computing device 880. It will be appreciated that the network connections shown are exemplary and other means of establishing a communications link between the computing devices may be used.

As discussed, the computing system may include a processor, a memory, a built in battery to power the computing device, an AC power input, potentially a built-in video camera, a display screen, a built-in Wi-Fi circuitry to wirelessly communicate with a remote computing device connected to network.

It should be noted that the present design can be carried out on a computing system such as that described with respect to FIG. 1. However, the present design can be carried out on a server, a computing device devoted to message handling, or on a distributed system in which different portions of the present design are carried out on different parts of the distributed computing system.

Another device that may be coupled to bus 811 is a power supply such as a battery and Alternating Current adapter circuit. As discussed above, the DC power supply may be a battery, a fuel cell, or similar DC power source that needs to be recharged on a periodic basis. The wireless communication module 872 may employ a Wireless Application Protocol to establish a wireless communication channel. The wireless communication module 872 may implement a wireless networking standard such as Institute of Electrical and Electronics Engineers (IEEE) 802.11 standard, IEEE std. 802.11-1999, published by IEEE in 1999.

Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

### Network Environment

As discussed, FIG. 2 illustrates a block diagram of an embodiment of the network environment in which the techniques described may be applied. The network environment 200 has a communications network 220 that connects server computing systems 204A through 204F, and at least one or more client computing systems 202A, 202B. As shown, there may be many server computing systems 204A through 204F and many client computing systems 202A through 202B connected to each other via the network 220, which may be, for example, the Internet. Note, that alternatively the network 220 might be or include one or more of: an optical network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 202A and the server computing system 204A can both initiate and respond to communications, their communication may be viewed as peer-to-peer. Likewise, communications between the client computing systems 204A and 204-2, and the server computing systems 202A and 202B may be viewed as peer-to-peer if each such communicating device is capable of initiation and response to communication. Additionally, server computing systems 204A-204F also have circuitry and software to communication with each other across the network 220. One or more of the server computing systems 204A to 204F may be associated with a database such as, for example, the databases 206A to 206F. Each server may have one or more instances of a virtual server running on that physical server and multiple virtual instances may be implemented by the design. A firewall may be established between a client computing system 202A and the network 220 to protect data integrity on the client computing system 202A. Each server computing system 204A-204F may have one or more firewalls.

In an embodiment, the Ad network is hosted on a cloud-based provider site that contains one or more servers 204A and one or more databases 206A.

A cloud provider service can install and operate application software in the cloud and users can access the software service from the client devices. Cloud users who have a site in the cloud may not solely manage the cloud infrastructure and platform where the application runs. Thus, the servers and databases may be shared hardware where the user is given a certain amount of dedicate use of these resources. The user's is given a virtual amount of dedicated space and bandwidth in the cloud. Cloud applications can be different from other applications in their scalability—which can be achieved by cloning tasks onto multiple virtual machines at run-time to meet changing work demand. Load balancers distribute the work over the set of virtual machines. This process is transparent to the cloud user, who sees only a single access point.

The cloud-based Ad network is coded to utilize a protocol, such as Hypertext Transfer Protocol (HTTP), to engage in a request and response cycle with both a mobile device application resident on a client device as well as a web-browser application resident on the client device. The cloud-based Ad network can be accessed by a mobile device, a desktop, a tablet device, and other similar devices, anytime, anywhere. Thus, the cloud-based Ad network hosted on a cloud-based provider site is coded to engage in 1) the request and response cycle from all web browser based applications, 2) SMS/twitter based request and response message exchanges, 3) the request and response cycle from a dedicated on-line server, 4) the request and response cycle directly between a native mobile application resident on a client device and the cloud-based Ad network, and 5) combinations of these.

The cloud-based Ad network has one or more application programming interfaces (APIs) with two or more of the customer sites as well as application programming interfaces with search engines and social on-line sites, etc. The APIs may be a published standard for the connection to each site for access/connectivity′ system. The APIs may also be an open source API. One or more of the API's may be customized to closed/non-published APIs of a remote access/connectivity′ site. The cloud-based Ad network is coded to establish a secure communication link between each customer entity site and the cloud provider site. The software service can be coded to establish the secure communication link by creating a tunnel at the socket layer and encrypting any data while in transit between each customer entity sites and the provider site as well as to satisfy any additional authentication mechanisms required by that site, including but not limited to IP address white listing and token based authentication.

In an embodiment, the server computing system 204 may include a server engine, a web page management component, a content management component and a database management component. The server engine performs basic processing and operating system level tasks. The web page management component handles creation and display or routing of web pages or screens associated with receiving and providing digital content and digital advertisements. Users may access the server-computing device by means of a URL associated therewith. The content management component handles most of the functions in the embodiments described herein. The database management component includes storage and retrieval tasks with respect to the database, queries to the database, and storage of data.

An embodiment of a server computing system to display information, such as a web page, etc. An application including any program modules, when executed on the server computing system 204A, causes the server computing system 204A to display windows and user interface screens on a portion of a media space, such as a web page. A user via a browser from the client computing system 202A may interact with the web page, and then supply input to the query/fields and/or service presented by a user interface of the application. The web page may be served by a web server computing system 204A on any Hypertext Markup Language (HTML) or Wireless Access Protocol (WAP) enabled client computing system 202A or any equivalent thereof. For example, the client mobile computing system 202A may be a smart phone, a touch pad, a laptop, a netbook, etc. The client computing system 202A may host a browser to interact with the server computing system 204A. Each application has a code scripted to perform the functions that the software component is coded to carry out such as presenting fields and icons to take details of desired information. Algorithms, routines, and engines within the server computing system 204A take the information from the presenting fields and icons and put that information into an appropriate storage medium such as a database. A comparison wizard is scripted to refer to a database and make use of such data. The applications may be hosted on the server computing system 204A and served to the browser of the client computing system 202A. The applications then serve pages that allow entry of details and further pages that allow entry of more details.

### Scripted Code

In regards of viewing ability of an on-line site: the scripted code for the on-line site, such as a website, social media site, etc., is configured to adapted to be i) viewed on tablets and mobile phones, such as individual downloadable applications in data stores that are designed to interface with the on-line site, ii) viewable on a screen in a vehicle or other mobile device, as well as iii) viewable on a screen of a desktop computer via a browser. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like.

Mobile web applications and native applications can be downloaded from a cloud-based site. The mobile web applications and native applications have direct access to the hardware of mobile devices (including accelerometers and GPS chips), and the speed and abilities of browser-based applications. Information about the mobile phone and the vehicle's location is gathered by software housed on the phone.

One or more scripted routines for the cloud-based Ad network are configured to collect and provide features such as those described herein.

Any application and other scripted code components may be stored on a non-transitory computing machine-readable medium which, when executed on the server causes the server to perform those functions. The applications including program modules may be implemented as logical sequences of software code, hardware logic circuits, and any combination of the two, and portions of the application scripted in software code are stored in a non-transitory computing device readable medium in an executable format. In an embodiment, the hardware logic consists of electronic circuits that follow the rules of Boolean Logic, software that contain patterns of instructions, or any combination of both.

The design is also described in the general context of computing device executable instructions, such as program modules etc. being executed by a computing device. Generally, program modules include routines, programs, objects, applications, widget, plug-ins, and other similar structures that perform particular tasks or implement particular abstract data types. Those skilled in the art can implement the description and/or figures herein as computer-executable instructions, which can be embodied on any form of computing machine-readable media discussed herein.

Some portions of the detailed descriptions herein are presented in terms of algorithms/routines and symbolic representations of operations on data bits within a computer memory. These algorithmic descriptions and representations are the means used by those skilled in the data processing arts to most effectively convey the substance of their work to others skilled in the art. An algorithm/routine is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms/routine of the application including the program modules may be written in a number of different software programming languages such as C, C++, Java, XML, HTML, or other similar languages.

Many online pages on a server, such as web pages, are written using the same language, Hypertext Markup Language (HTML), which is passed around using a common protocol—HTTP. HTTP is the common Internet language (dialect, or specification). Through the use of a web browser, a special piece of software that interprets HTTP and renders HTML into a human-readable form, web pages authored in HTML on any type of computer can be read anywhere, including telephones, PDAs and even popular games consoles. Because of HTTP, a client machine (like your computer) knows that it has to be the one to initiate a request for a web page; it sends this request to a server. A server may be a computing device where web sites reside—when you type a web address into your browser, a server receives your request, finds the web page you want, and sends it back to your desktop or mobile computing device to be displayed in your web browser. The client device and server may bilaterally communicate via a HTTP request & response cycle between the two.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

Although embodiments of this design have been fully described with reference to the accompanying drawings, it is to be noted that various changes and modifications will become apparent to those skilled in the art. Such changes and modifications are to be understood as being included within the scope of embodiments of this design as defined by the appended claims. The invention is to be understood as not limited by the specific embodiments described herein, but only by scope of the appended claims.

What is claimed is:

1. An advertisement network, comprising:
an analytics engine configured to collect and analyze signal data about tracked statistics and data on advertising effectiveness and search information;
an Ad server;
wherein the analytics engine is configured to work with the Ad server; and
a database configured to store multiple instances of one or more product video advertisements (“PVAs”), each of the multiple instances varying in content and containing an embedded link,
wherein the database has an index of the multiple instances of the one or more PVAs, and
wherein the analytics engine is configured to work with the Ad server to select and deliver a first instance of a PVA optimized for a search engine-results page based on the signal data.

2. The advertisement network of claim 1,
wherein the advertisement network is configured for optimizing the PVAs by inserting relevant information obtained regarding organic search information as well as using paid media to boost the visibility of the PVAs,
wherein the advertisement network is configured to connect advertisers to advertisement-hosting or advertisement-publishing on-line sites,
wherein the advertisement network is configured to use the Ad server to deliver the PVAs as downloaded content to consumers on their client devices, which enables targeting of the PVAs to a specific group of the consumers,
wherein the Ad server is an on-line server backed by the database configured to deliver the PVAs in the database to client devices of the consumers, and
wherein the signal data supplied to the Ad server from the analytics engine is constantly updated from on-line sites visited by the consumers as well as by downloading analytical and tracked data from two or more sites selected from search engine sites, social media sites, video playing sites, and other on-line sites.

3. The advertisement network of claim 1,
further comprising a video library in the database configured to store and index the PVAs,
wherein the advertisement network is configured to create link processing and integrate into the video library stored in the database that is configured to cooperate with the Ad server,
wherein the video library has an index of retail products and services such that a given retailer's entire product selection has one or more instances of the one or more PVAs with embedded links in the PVAs,
wherein each specific retail product or service can have the multiple instances of the PVAs on the specific retail product or service, where the PVA-varying content is selected from different male or female voices, different color backgrounds for the retail product in the PVA, different images of the retail product, different music playing in the PVA, and the like,
wherein the analytics engine is configured to determine which instance of the PVA is currently getting the most consumers to partly or entirely watch the PVA and click through the embedded link in the PVA,
wherein the Ad server is configured to subsequently deliver that instance of the PVA, and
wherein each of the PVAs is a video on the retail product or service rather than a mere single static image of the specific retail product.

4. The advertisement network of claim 3,
wherein the analytics engine is configured to keep a real time track of current statistics of parameters selected from advertisement click per cost and advertisement click per action such as click-and-view the PVA,
wherein the signal data supplied to the Ad server from the analytics engine is constantly updated from sites visited by the consumers as well as from downloading analytical and tracked data from the one or more sites selected from search engine sites, social media sites, video playing sites, and other sites,
wherein the analytics engine is configured to use one or more algorithms to weight the signal data to determine which instance of the PVA will be the most relevant,
wherein the analytics engine is configured to use both organic media and paid media to affect the weighting by the one or more algorithms, and
wherein one or more routines are configured to
a) go to multiple different types of media platforms selected from i) browser-search engine databases, ii) video playing sites, and iii) social media sites, to collect tracked statistics and parameters about advertisements, and
b) cost basis average the tracked statistics and parameters from the multiple different types of media platforms to determine performance of that particular instance of the PVA to determine which instance of the PVA will be the most relevant.

5. The advertisement network of claim 1,
wherein the advertisement network is built and configured to optimize media buys to deliver performance metrics that advertisers are seeking on a cost-per-click basis, a cost-per-action basis, or a combination thereof,
wherein the advertisement network is configured to obtain tracked statistics and analytics from multiple different types of media platforms and provide geographic and demographic targeting based upon consumer behavior, and
wherein the advertisement network is configured to buy impressions on a per spot basis on behalf of advertisers and subsequently adjust bids in accordance with advertisers' goals.

6. The advertisement network of claim 5,
further comprising an algorithm of the analytics engine configured to collect different types of performance metrics and tracked parameters from each of a number of databases of the multiple different types of media platforms to support multiple different cost metrics from two or more different advertisers,
wherein a first advertiser may use a first set of cost metrics including cost-per-click metrics and a second advertiser may use a second set of cost metrics including cost-per-action metrics,
wherein the analytics engine is configured to collect different types of performance metrics from each of the number of databases to have the statistics to receive the different cost metrics from the different advertisers and tailor performance results to cost metric criteria that a particular advertiser is using, and
wherein the algorithm is configured to query a particular media platform's database to pull and collect tracked data of the different types of performance metrics and tracked parameters and then return that tracked data into a reference database that the analytics engine is configured to use when tailoring the performance results to the cost metric criteria that the particular advertiser is using.

7. The advertisement network of claim 1,
wherein the advertisement network is built and configured to use a combination of both free organic traffic including at least top listings on a search engine-results page as well as paid traffic in any network to use in the signal data,
wherein the advertisement network is configured to optimize each advertisement campaign and deliver clicks based upon real time bidding by advertisers, matching qualified shoppers to the advertisers and earning the largest spread between buying a click and selling to the advertisers, and
wherein the analytics engine receives signal data from organic traffic such as key word searches related to a retail product
add user signal data from organic traffic to update tags in a corresponding PVA.

8. The advertisement network of claim 1,
wherein the analytics engine is configured to bid on paid media on behalf of advertisers and to use a factor of paid advertisements,
wherein the advertisement network's PVAs incorporate search engine optimizations into metadata and/or the content of the PVAs to cause the PVAs to surface organically in search engine-results pages,
wherein the advertisement network is configured to buy traffic programmatically from other networks to boost margins and meet advertiser performance goals, and
wherein information selected from key word searches, current trends, and the like is incorporated into the metadata and/or the content of the PVAs themselves as well as is used in organic traffic determinations.

9. The advertisement network of claim 1, further comprising
a PVA-generation engine configured to produce for a specific retail product, two or more instances of the PVAs on the retail product with the content selected from different male or female voices, different color backgrounds for the retail product in the PVA, different images of the retail product, different music playing in the PVA, retailer's logo or brand as a product image overlay inserted into the PVAs, and the like,
wherein the advertisement network is configured to make and provide PVAs with embedded links, each of which embedded links is configured to direct a browser or application of a mobile device viewing a PVA directly to a relevant retailer's web site or call center that offers similar products to those viewed by a user of the mobile device when watching the PVA, and
wherein the PVA-generation engine stores the multiple instances of the PVAs in the database.

10. The advertisement network of claim 9,
wherein the PVA-generation engine is a full-featured, automated production suite configured to allow a video template to be built by an operator and subsequently use the template to create an unlimited number of PVAs based on the template,
wherein the PVA-generation engine is configured to allow the operator to choose multiple PVA elements and place them into a timeline for the PVA in any sequence, and
wherein the multiple PVA elements are pre-set and when a processor runs the template it will automatically pull in the PVA elements and render a finished PVA.

11. The advertisement network of claim 9,
wherein the PVA-generation engine is configured to insert or present one or more user interfaces to allow the operator to insert PVA elements along a timeline,
wherein the PVA elements are selected from video elements such as a Cam Lead, an On Cam Tag, a Product Video, a Background Animation, or a Closer; image elements such as a Background or one or more Product Images; operator-generated elements such as Text, Bullet Points, or Overlay; and audio elements such as Voiceover, Music, or Sound Effects, and
wherein the PVA engine incorporates the selected video elements into a given instance of the PVA and then stores that instance of the PVA in the database.

12. The advertisement network of claim 1, further comprising
an ingest engine configured to receive a retail product or service feed,
wherein the retail product feed has specifics about a retail product;
an analytics engine portion of the analytics engine configured to provide the signal data to the ingest engine,
wherein the ingest engine is configured to guide an operator through Product Selection, Script, and Video Production and insert Video Metadata based on the signal data received from the analytics engine;
a video processor configured to create the multiple instances of the one or more PVAs varying in content,
wherein the video processor adds custom branding into the PVAs to allow the multiple instances of the PVAs to be branded to a particular retailer; and
a video publisher configured to finish off each of the multiple instances of the one or more PVAs for video publication.

13. The advertisement network of claim 1,
wherein each instance of the PVA is 10-30 seconds with the embedded link configured to direct a browser or application of a mobile device to a relevant retailer's site or call center that offers similar products to those viewed by a user of the mobile device when watching the PVA,
wherein the PVA is configured to present the embedded link to a consumer on a client device to have the opportunity to click through to one or more advertisers' on-line sites, call centers, or other on-line sites,
wherein the consumer may enter as a highly qualified prospect in purchasing the product from the PVA.

14. The advertisement network of claim 1,
wherein the advertisement network is configured with one or more user interfaces to allow real time bidding by multiple advertisers,
wherein the advertisement network is configured to utilize a network flow analyzer to assist in traffic reporting, and
wherein the advertisement network is configured to employ advertisement-serving technology to provide software to on-line sites and advertisers to serve advertisements including the PVAs, count the PVAs, choose the advertisements projected to make the on-line sites or advertisers the most money, and monitor progress of different advertising campaigns.

15. The advertisement network of claim 1,
wherein a list of online advertising space that the advertisement network is configured to deliver advertisements to includes space on on-line sites such as web sites, in RSS feeds, on blogs, in instant messaging applications, in adware, in e-mails, and in or on other sources, and
wherein the advertisement network is configured with one or more user interfaces to allow real time bidding by multiple advertisers, thus, the advertisement network is configured to allow multiple advertisers to bid in real time for clicks from user's devices associated with each PVA.

16. A method, comprising:
receiving into an ingest engine database of an advertisement network a product data feed from an advertiser via one or more RSS feeds and/or user interfaces;
parsing the product data feed by the ingest engine to identify and index key points about one or more products in the product data feed;
scanning available content found online regarding the one or more products by an analytics engine;
creating with a video processor one or more instances of one or more product video advertisements (“PVAs”) from the product data feed and the content found online; and
publishing the one or more PVAs online with a video publisher.

17. The method of claim 16, further comprising
using a PVA template built by an operator to create the one or more instances of the one or more PVAs with the video processor,
wherein the video template contains one or more PVA elements selected by the operator in a PVA-generation engine and placed in a PVA-template timeline, and
wherein the PVA elements are selected from video elements, image elements, operator-generated elements, and audio elements; and
running the PVA template with a processor, automatically pulling in the PVA elements selected by the operator to create the one or more instances of the one or more PVAs.

18. The method of claim 16, further comprising
optimizing the one or more PVAs to index organically as organic PVAs in search engine-result pages;
receiving data signals corresponding to the organic PVAs; and
analyzing the data signals to identify high-interest PVAs from the organic PVAs that are receiving the most interest.

19. The method of claim 17, further comprising
placing spot bids on various media to display the high-interest PVAs in paid traffic;
optimizing the high-interest PVAs to provide the lowest cost-highest value possible in optimized PVAs; and
receiving real time bids from advertisers for traffic, clicks, actions, or a combination thereof associated with the optimized PVAs.

20. The method of claim 16, further comprising
playing the one or more PVAs for a consumer,
wherein the one or more PVAs are hosted on the advertising network or another network; and
sending the consumer to an appropriate advertiser based upon a margin between any given advertisers' maximum bid and a cost to secure the consumer in real time.
